(19) United States
(12) Patent Application Publication
(10) Pub. No.: US 2025/0159543 A1
(43) Pub. Date: May 15, 2025

(54) TRAFFIC CLASSIFICATION (TCLAS) ENHANCEMENT FOR LOW LATENCY, LOW LOSS, SCALABLE (L4S) THROUGHOUT FLOW CLASSIFICATION

(71) Applicant: Cisco Technology, Inc., San Jose, CA (US)

(72) Inventors: Binita Gupta, San Diego, CA (US); Juan Carlos Zuniga, Montreal (CA); Jerome Henry, Pittsboro, NC (US); Brian D. Hart, Sunnyvale, CA (US)

(73) Assignee: Cisco Technology, Inc., San Jose, CA (US)

(21) Appl. No.: 18/947,727

(22) Filed: Nov. 14, 2024

Related U.S. Application Data
(60) Provisional application No. 63/598,929, filed on Nov. 14, 2023.
(60) Provisional application No. 63/640,173, filed on Apr. 29, 2024.
(60) Provisional application No. 63/648,484, filed on May 16, 2024.

(51) Int. Cl. H04W 28/02; H04L 47/31; H04W 72/12

(52) U.S. Cl. CPC H04W 28/0268; H04L 47/31; H04W 72/12

(57) ABSTRACT

A Traffic Classification (TCLAS) element enhancement for Low Latency, Low Loss, Scalable Throughout (L4S) flow classification may be provided. First, a client device may determine that a flow is an L4S flow. Next, the client device may communicate that the flow is L4S using an enhanced TCLAS element. Then an Access Point (AP) may use the enhanced TCLAS element to schedule the flow.

### RELATED APPLICATION

Under provisions of 35 U.S.C. § 119(e), Applicant claims the benefit of U.S. Provisional Application No. 63/598,929 filed Nov. 14, 2023, which is incorporated herein by reference. Furthermore, under provisions of 35 U.S.C. § 119(e), Applicant claims the benefit of U.S. Provisional Application No. 63/640,173 filed Apr. 29, 2024, which is incorporated herein by reference.

### TECHNICAL FIELD

The present disclosure relates generally to providing Traffic Classification (TCLAS) enhancement for Low Latency, Low Loss, Scalable (L4S) throughout flow classification.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Traffic Classification (TCLAS) enhancement for L4S flow classification;

FIG. 2 is a flow chart of a method for providing Traffic Classification (TCLAS) enhancement for L4S flow classification;

FIG. 3 illustrates a TCLAS element format;

FIG. 4 illustrates a frame classifier file format;

FIG. 5 illustrates a frame classifier field format;

FIG. 6 illustrates a frame classifier field format;

FIG. 7 illustrates a frame classifier field format;

FIG. 8 illustrates a frame classifier field format;

FIG. 9 illustrates a frame classifier field format;

FIG. 10 illustrates L4S considerations for Stream Classification Service (SCS) based scheduling; and

FIG. 11 is a block diagram of a computing device.

### DETAILED DESCRIPTION

### Overview

A Traffic Classification (TCLAS) element enhancement for Low Latency, Low Loss, Scalable Throughout (L4S) flow classification may be provided. First, a client device may determine that a flow is an L4S flow. Next, the client device may communicate that the flow is L4S using an enhanced TCLAS element. Then an Access Point (AP) may use the enhanced TCLAS element to schedule the flow.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Low Latency, Low Loss, Scalable Throughout (L4S) is an architecture and protocol defined in Internet Engineering Task Force standards with the purpose to provide low queuing latency, low congestion loss, and scalable throughput control for streaming video, multiplayer games, and other real-time applications for example. The architecture assumes: i) the existence of a scalable congestion control at the sender host, capable of keeping an average time from one congestion signal to the next, as the flow rate scales; ii) L4S packet identifier at the Internet Protocol (IP) layer, and as well as support for Explicit Congestion Notification (ECN) feedback in a fine-grained fashion, to be used as explicit congestion control signaling protocol; iii) capability to isolate traffic in separate queues, so that L4S traffic can be kept on a shallow queue; and iv) a conditional priority scheduler that may give preference to L4S traffic over other types of traffic.

The concept has proven to be beneficial in several network environments. However, wireless shared media access is typically stochastic and hard to predict. This may be true in dense wireless environments with multiple clients trying to access the medium simultaneously. The Institute of Electrical and Electronics Engineers (IEEE) 802.11 standard defines TCLAS element for classification of traffic flows. The TCLAS element may support classifying flows based on fields in the IP header. For example, TCLAS may be used to classify packets based on their Internet Protocol (IP) tuple or based on a Differentiated Service Code Point (DSCP) value in the IP header. Now with the L4S protocol defined, the 2 ECN bits in the IP header may be used to tag L4S data packets. It becomes important to enhance the TCLAS to be able to signal classification of L4S packets based on ECN bits, so that L4S flow classification may be used to prioritize L4S packets over Wi-Fi. Embodiments of the disclosure may provide TCLAS enhancements for L4S flow classification that may be used to prioritize L4S packets over Wi-Fi to achieve low latency and low loss treatment for L4S flows.

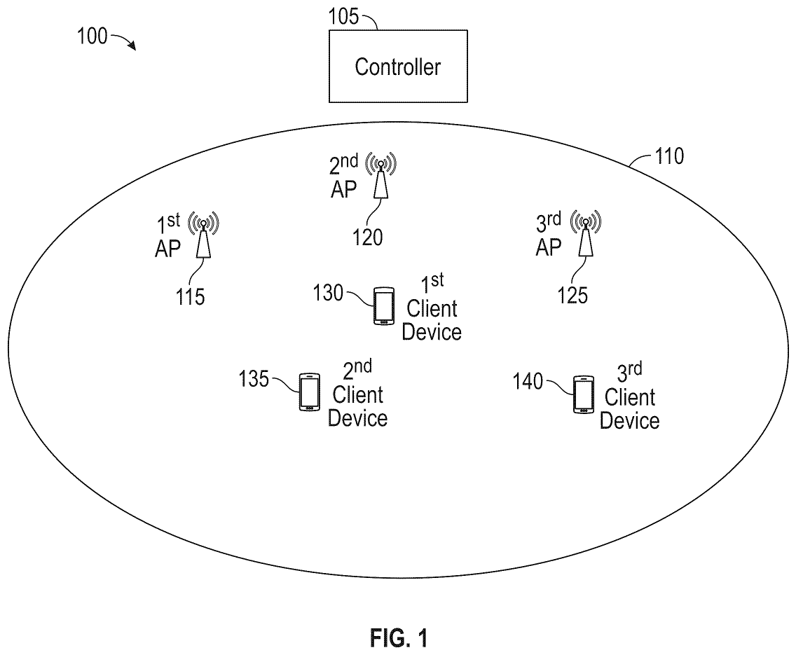

FIG. 1 shows an operating environment 100 for providing TCLAS enhancement for L4S flow classification. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs (e.g., AP Stations (STAs)) may comprise a first AP 115, a second AP 120, a third AP 125. The plurality of APs may provide wireless network access to a plurality of client devices as they move within coverage environment 110. The plurality of client devices (e.g., non-AP STAs) may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHZ band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide TCLAS enhancement for L4S flow classification.

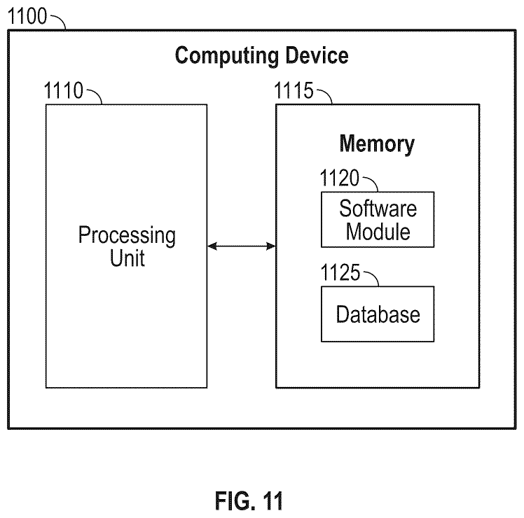

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 11, the elements of operating environment 100 may be practiced in a computing device 1100.

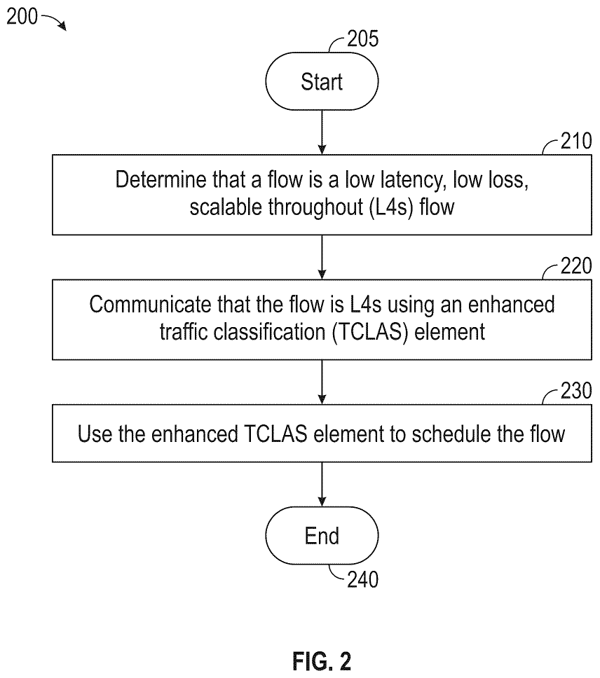

FIG. 2 is a flow chart setting forth the general stages involved in a method 200 consistent with embodiments of the disclosure for providing TCLAS enhancement for L4S flow classification. Method 200 may be implemented using computing device 1100 as described in more detail below with respect to FIG. 11. Computing device 1100 may be embodied by first AP 115 and/or first client device 130. Ways to implement the stages of method 200 will be described in greater detail below.

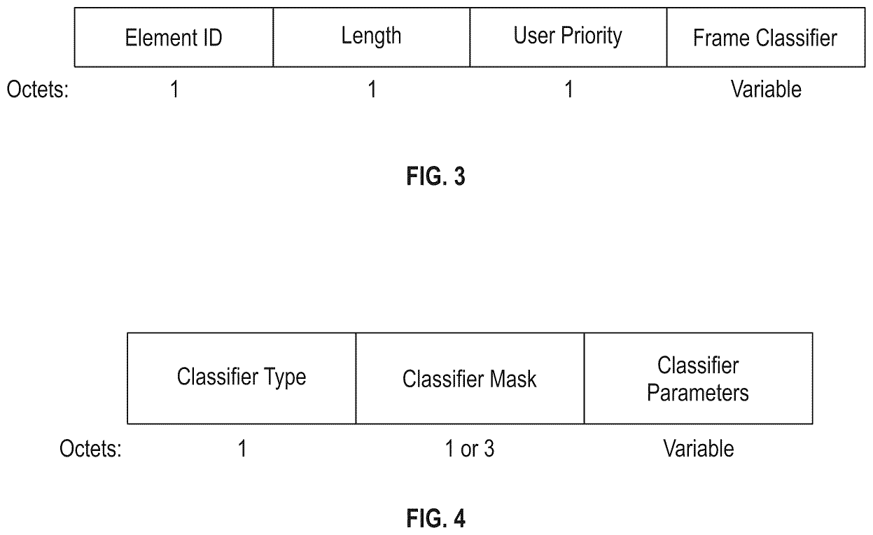

FIG. 3 illustrates a TCLAS element format. As shown in FIG. 3, the TCLAS element may define different Classifier Types to classify traffic flows. FIG. 4 illustrates a frame classifier file format. Classifier Type 1 and Classifier Type 4, for example, are defined for classification of flow packets based on Internet Protocol (IP) layer parameters as shown in Table 1 below.

TABLE 1
Table 9-201-Frame classifier type

| Classifier | |
|---|---|
| type | Classifier parameters |
| 0 | [symbol] |
| 1 | ICP UDP IP [symbol] |
| 2 | IEEE [symbol] |
| 3 | Fiber [symbol] |
| 4 | IP and [symbol] layer [symbol] |
| 5 | IEEE [symbol] |
| 6 | IEEE [symbol] |
| 7 | IEEE [symbol] |
| 8 | IEEE [symbol] |
| 9 | IEEE [symbol] |
| 10 | IP [symbol] |
| 11- [symbol] | Reserved |

[symbol]

indicates data missing or illegible when filed

Method 200 may begin at starting block 205 and proceed to stage 210 where first client device 130 may determine that a flow is a Low Latency, Low Loss, Scalable Throughout (L4S) flow. For example, an application running on first client device 130 may establish an L4S with flow first AP 115. First client device 130 may determine that the flow is an L4S flow.

From stage 210, where first client device 130 determines that the flow is an L4S flow, method 200 may advance to stage 220 where first client device 130 may communicate that the flow is L4S using an enhanced Traffic Classification (TCLAS) element. For example, embodiments of the disclosure may provide an enhance TCLAS Classifier Type 1 and Classifier Type 4 to support classifying L4S packets by supporting classification of IP packets based on the ECN bits in an IP header. For example, the ECN(01) and ECN(11) may identify L4S data packets.

### Classifier Type 1 Enhancement

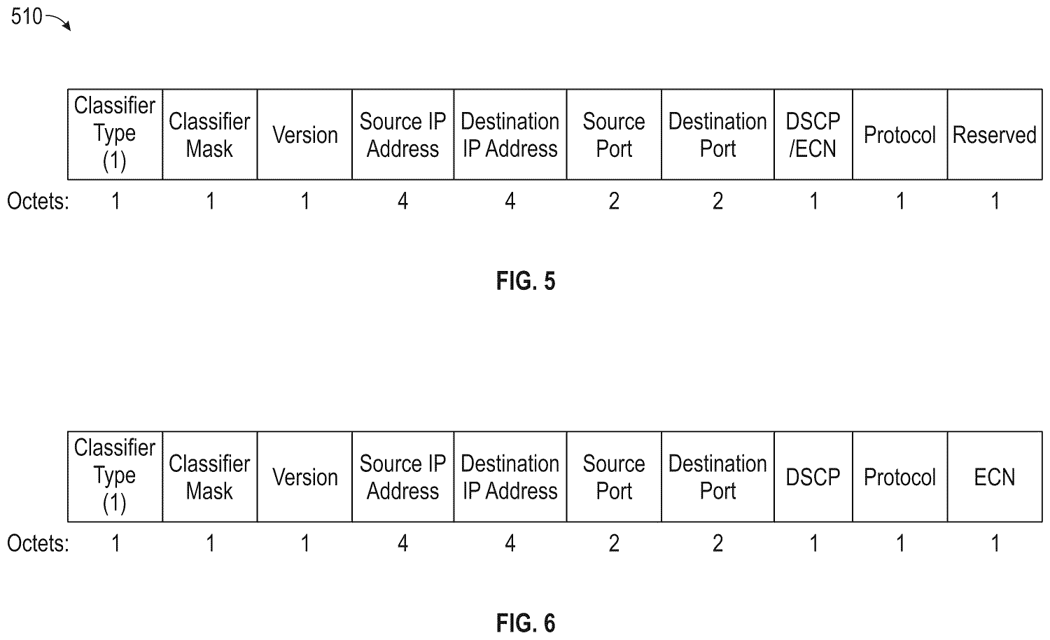

There may be two ways the Classifier Type 1 may be enhanced to support flow classification for L4S packets for IPV4. A first way may be illustrated by FIG. 5 that shows a frame classifier field format of Classifier Type 1 for traffic over IPv4. Embodiments of the disclosure may repurpose the existing DSCP field (1 octet) to be used for classifying based on both DSCP and/or ECN bits and rename it to DSCP/ECN field. The two Most Significant Bits (MSBs) of the new DSCP/ECN field may be set to indicate ECN bits value (01 or 11) to classify for the L4S flow packets. The 6 Least Significant Bits (LSBs) may be used for DSCP based IP packets classification.

A second way may be illustrated by FIG. 6 that shows a frame classifier field format of Classifier Type 1 for traffic over IPv4. Embodiments of the disclosure may use the Reserved field and use it for the ECN field. Either the two LSBs of the new ECN field or the two MSBs of the ECN field may be set to indicate ECN bits value (01 or 11) to classify for the L4S flow packets. Note that the use of Classifier Type 1 is deprecated for IPV6 in TCLAS, hence Classifier Type 1 may not need to be enhanced for IPV6.

### Classifier Type 4 Enhancement

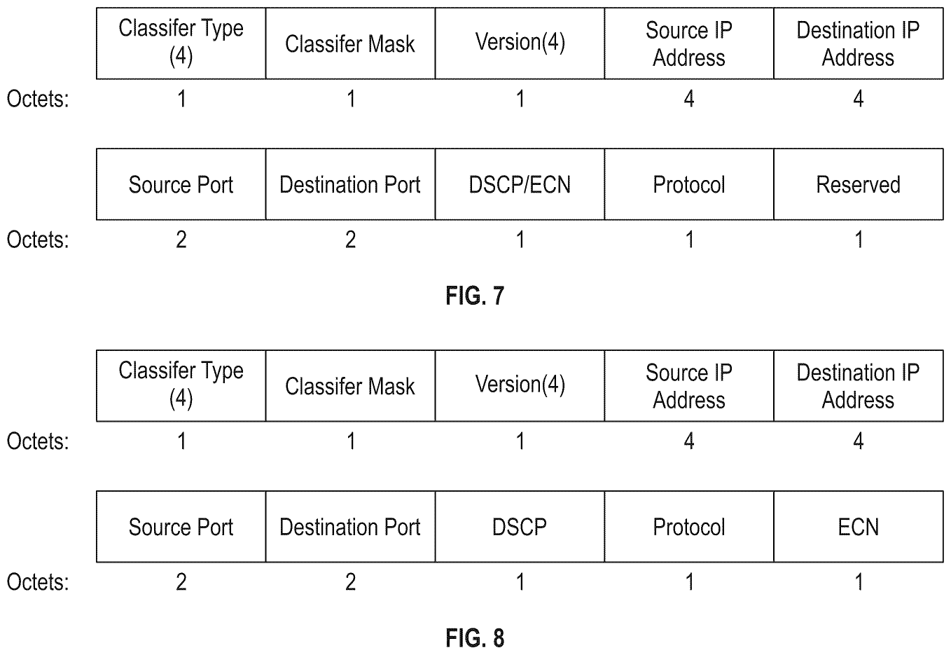

The Classifier Type 4 may be enhanced to support flow classification for L4S packets for both IPv4 and IPV6. Embodiments of the disclosure may enhance the Classifier Type 4 for IPV4 in two ways as shown in FIG. 7 and FIG. 8, similar to those used for enhancements to Classifier Type 1 shown in FIG. 5 and FIG. 6 respectively.

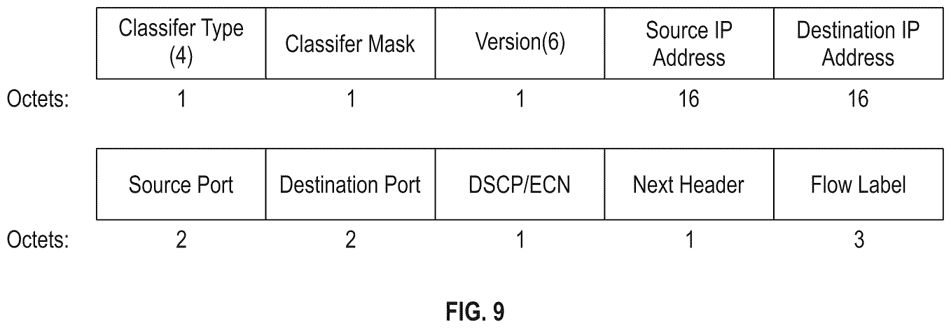

Embodiments of the disclosure may enhance Classifier Type 4 for IPV6 as shown in FIG. 9, by repurposing the DSCP field to be used for both DSCP and ECN based classification of packets and renaming it to DSCP/ECN field. The two MSB bits of the new DSCP/ECN field may be set to indicate ECN bits value (01 or 11) to classify the L4S flow packets. The 6 LSB bits may be used for DSCP based IP packets classification.

Once first client device 130 communicates that the flow is L4S using the enhanced TCLAS element in stage 220, method 200 may continue to stage 230 where first AP 115 may use the enhanced TCLAS element to schedule the flow. For example, first AP 115 may prioritize and schedule the L4S flow based on the enhanced TCLAS element. Once first AP 115 uses the enhanced TCLAS element to schedule the flow in stage 230, method 200 may then end at stage 240.

In another embodiment, the same enhanced TCLAS element may be used to classify packets which are both L4S and match a specific DSCP values as well (e.g., DSCP 46). In yet another embodiment, the enhanced TCLAS may be used to classify L4S packets belonging to a specific IP tuple, by specifying both IP tuple and ECN bits information in the TCLAS.

In yet another embodiment, the enhanced TCLAS element may be used by the STA (e.g., client device) to ask the AP to classify DL L4S packets, by setting the ECN bits in the enhanced TCLAS element, and map it to a specific UP/Traffic ID (TID) using the Stream Classification Service (SCS)+TCLAS for DL. In yet another embodiment, the enhanced TCLAS element may be used by the AP to ask the STA to classify UL L4S packets, by: i) setting the ECN bits in the enhanced TCLAS element and map L4S packets to a specific UP/Traffic ID (TID) by sending unsolicited SCS message with a TCLAS with mapped UP/TID information; or ii) setting the ECN bits in the enhanced TCLAS element and map L4S packets to a specific DSCP value by sending a DSCP policy message (e.g., as defined in WFA QoS Management) with that TCLAS and a mapped DSCP value.

Considering an IPV4 classifier wherein the DSCP field is converted to a DSCP/ECN field, and matching all 8 bits of DSCP+ECN (DSCP 6 bits+ECN 2 bits)), embodiments of the disclosure may provide extensions so that the STA may be able to signal how to match the DSCP/ECN bits to classify packets: a) Match only DSCP bits (will ignore ECN values); b) Match only ECN bits (will ignore DSCP values); c) Match both DSCP and ECN bits (will match all 8 bits); d) Match only MSB bit in ECN (bit 6) (will match only bit 6); and e) Match other subsets of these 8 bits. This classifier handling for DSCP/ECN bits may be signaled in the TCLAS Processing element, e.g. by: i) using a different Processing field value: e.g. Value 3, 4, 5, 6 for the Processing field indicates each of the match options above for DSCP/ECN field; or ii) add another DSCP/ECN classifier bitmask (1 octet) indicating which bits of the DSCP/ECN field should be mapped for matching the IP packets for classification. For example, for L4S flows, the DSCP/ECN classifier bitmask may indicate to match only MSB bit (bit 6) and in the DSCP/ECN field in the bit 6 is indicated as “1” matching both ECN=01 or ECN=11 for L4S flows. Similarly, value b′11111111 indicates matching both ECN and DSCP, b′10111111 indicates matching DSCP and (ECN=01 or ECN=11). Where first bit indicates the MSB and the last bit indicates the LSB. The same extension to the TCLAS Processing element may be used for Classifier Type 4 for IPV6, to signal how to match bits in the DSCP/ECN field.

In yet another embodiment, a new Classifier Type (e.g., Classifier Type 11) may also be defined for IPV4 and/or IPv6 with following: a) indicates ECN as a separate field for both IPv4 and IPV6, and uses Classifier Mask of 2 octets, to indicate matching for fields; or b) defines classifier mask based on bit matching for DSCP and/or ECN fields, and for other IP header fields uses bits to indicate field matching.

As well, APs and client devices may indicate support for these new classifiers/classifier fields/masks via a capability bit, in the Extended Capabilities element and/or the Ultra High Reliability (UHR) capabilities element. If mandatory for IEEE 802.11bn, this may be indicated through the presence of the UHR Capabilities element; else the capability might be conditionally mandatory, given support for L4S so this might be a non-zero value in a more general L4S capability field, or it might be specific bit(s)/field for one or more of these new classifiers/classifier fields/masks.

### L4S Traffic Classification Using TCLAS

TCLAS in SCS may be used to classify L4S traffic based on ECN bits (01, 11) and indicate specific QoS for L4S flows. For example, using SCS, a STA may request: a) specific Delay Bound to be provided for L4S flows; or b) map L4S flows to a higher-QoS TID for better end-to-end latency; and c) for a Virtual Private Network (VPN) tunnel, where multiple flows map to same IP-tuple, TCLAS may classify just the L4S flows based on ECN.

To enable classification of L4S flows, TCLAS may be extended to classify based on ECN. For Classifier Type 4, DSCP field may be redefined to be interpreted as indicating DSCP, ECN or both—the 2 MSB bits indicate ECN. TCLAS may be used to indicate an L4S flow, by including two TCLAS elements—one with ECN=01, and another with ECN=11, and TCLAS Processing element indicates ‘either match’. ECN based classification may be used if supported by both sides (AP and STA).

### L4S Considerations for SCS Based Scheduling

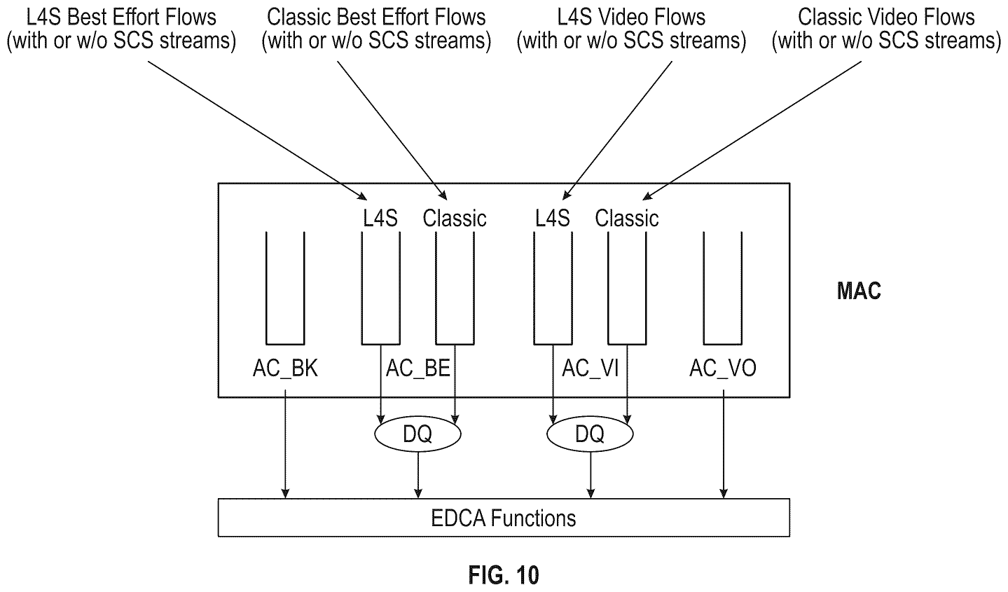

As illustrated by FIG. 10, if an SCS flow is also an L4S flow, then the STA may indicate that to the AP (using TCLAS enhancement). The AP may use this information in SCS based resource allocation and applying any L4S based policy, even before the flow has started. For UL if the TCLAS not included, can indicate that the SCS request is for an L4S flow in QoS Characteristics element (e.g., using a reserved bit in the control information). L4S flows may or may not have SCS streams. Irrespective, L4S flows may always be mapped to L4S queues. SCS based scheduling may attempt to meet QoS characteristics of SCS flows (either classic or L4S flows), while trying to keep shallow queues for L4S flows (which could have SCS streams created) as much as possible.

### L4S Capability Signaling

Both peer STAs may need to signal support for L4S related capability, for L4S enhancements to be used. Depending upon features supported for L4S, following capability may be signaled: i) L4S Dual Queue AQM; ii) L4S Congestion signaling at L2 for downlink (using A-Control in the MAC header); iii L4S Congestion signaling at L2 for upstream L4S queues (on the AP) (Using A-Control or Using management frame); iv) TCLAS ECN classification for L4S; and v) L4S signaling in QoS Characteristics. L4S related capabilities may be signaled in the Extended Capabilities element and/or in the UHR Capabilities element.

FIG. 11 shows computing device 1100. As shown in FIG. 11, computing device 1100 may include a processing unit 1110 and a memory unit 1115. Memory unit 1115 may include a software module 1120 and a database 1125. While executing on processing unit 1110, software module 1120 may perform, for example, processes for providing TCLAS enhancement for L4S flow classification as described above with respect to FIG. 2. Computing device 1100, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 1100.

Computing device 1100 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1100 may comprise any computer operating environment, such as hand-held devices, multiprocessor systems, microprocessor-based or programmable sender electronic devices, minicomputers, mainframe computers, and the like. Computing device 1100 may also be practiced in distributed computing environments where tasks are performed by remote processing devices. The aforementioned systems and devices are examples, and computing device 1100 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1100 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining, by a client device, that a flow is a Low Latency, Low Loss, Scalable Throughout (L4S) flow;
communicating that the flow is L4S using an enhanced Traffic Classification (TCLAS) element; and
using, by an Access Point (AP), the enhanced TCLAS element to schedule the flow.

2. The method of claim 1, wherein the enhanced TCLAS element comprises an enhance TCLAS classifier Type 1 element.

3. The method of claim 2, wherein the enhance TCLAS classifier Type 1 element uses a Differentiated Service Code Point (DSCP) field based on at least one of DSCP bits and Explicit Congestion Notification (ECN) bits.

4. The method of claim 2, wherein the enhance TCLAS classifier Type 1 element uses a reserved field based on Explicit Congestion Notification (ECN) bits.

5. The method of claim 1, wherein the enhanced TCLAS element comprises an enhance TCLAS classifier Type 4 element.

6. The method of claim 5, wherein the enhance TCLAS classifier Type 1 element uses a Differentiated Service Code Point (DSCP) field based on at least one of DSCP bits and Explicit Congestion Notification (ECN) bits.

7. The method of claim 5, wherein the enhance TCLAS classifier Type 1 element uses a reserved field based on Explicit Congestion Notification (ECN) bits.

8. A system comprising:
a memory storage; and
a processing unit coupled to the memory storage and disposed in an Access Point (AP), wherein the processing unit is operative to:
receiving an enhanced Traffic Classification (TCLAS) element that indicates that a flow is Low Latency, Low Loss, Scalable Throughout (L4S); and
using the enhanced TCLAS element to schedule the flow.

9. The system of claim 8, wherein the enhanced TCLAS element comprises an enhance TCLAS classifier Type 1 element.

10. The system of claim 9, wherein the enhance TCLAS classifier Type 1 element uses a Differentiated Service Code Point (DSCP) field based on at least one of DSCP bits and Explicit Congestion Notification (ECN) bits.

11. The system of claim 9, wherein the enhance TCLAS classifier Type 1 element uses a reserved field based on Explicit Congestion Notification (ECN) bits.

12. The system of claim 8, wherein the enhanced TCLAS element comprises an enhance TCLAS classifier Type 4 element.

13. The system of claim 12, wherein the enhance TCLAS classifier Type 1 element uses a Differentiated Service Code Point (DSCP) field based on at least one of DSCP bits and Explicit Congestion Notification (ECN) bits.

14. The system of claim 12, wherein the enhance TCLAS classifier Type 1 element uses a reserved field based on Explicit Congestion Notification (ECN) bits.

15. A non-transitory computer-readable medium that stores a set of instructions which when executed perform a method executed by the set of instructions comprising:
determining, by a client device, that a flow is a Low Latency, Low Loss, Scalable Throughout (L4S) flow;
communicating that the flow is L4S using an enhanced Traffic Classification (TCLAS) element; and
using, by an Access Point (AP), the enhanced TCLAS element to schedule the flow.

16. The non-transitory computer-readable medium of claim 15, wherein the enhanced TCLAS element comprises an enhance TCLAS classifier Type 1 element.

17. The non-transitory computer-readable medium of claim 16, wherein the enhance TCLAS classifier Type 1 element uses a Differentiated Service Code Point (DSCP) field based on at least one of DSCP bits and Explicit Congestion Notification (ECN) bits.

18. The non-transitory computer-readable medium of claim 16, wherein the enhance TCLAS classifier Type 1 element uses a reserved field based on Explicit Congestion Notification (ECN) bits.

19. The non-transitory computer-readable medium of claim 15, wherein the enhanced TCLAS element comprises an enhance TCLAS classifier Type 4 element.

20. The non-transitory computer-readable medium of claim 19, wherein the enhance TCLAS classifier Type 1 element uses a Differentiated Service Code Point (DSCP) field based on at least one of DSCP bits and Explicit Congestion Notification (ECN) bits.
